(19) United States
(12) Patent Application Publication
(10) Pub. No.: US 2011/0254779 A1
(43) Pub. Date: Oct. 20, 2011

(54) TOUCH SCREEN DEVICE AND METHOD OF MANUFACTURING THE SAME

(76) Inventor: Jong Young LEE, Gyunggi-do (KR)

(21) Appl. No.: 12/814,219

(22) Filed: Jun. 11, 2010

(30) Foreign Application Priority Data
Apr. 14, 2010 (KR) 10-2010-0034454

(51) Int. Cl. G06F 3/041; B29C 65/02; B32B 37/12; B29C 65/52; B32B 37/02

(52) U.S. Cl. 345/173; 156/60; 156/325; 156/333; 156/331.7; 156/327

(57) ABSTRACT

Disclosed herein are a touch screen device and a method of manufacturing the same. The touch screen device includes: a touch screen; a display formed on one side of the touch screen; and an adhesive layer formed between the touch screen and the display, in which an adhesive portion is formed on the entire surface where the adhesive layer is in contact with the touch screen and on the edge portions of the surface where the adhesive layer is in contact with the display. Further, the touch screen device has improved transmittance by removing an air layer between the touch screen and the display and can be easily corrected when the touch screen is incorrectly bonded with the display.

### CROSS REFERENCE TO RELATED APPLICATION

This application claims the benefit of Korean Patent Application No. 10-2010-0034454, filed on Apr. 14, 2010, entitled “A Touch Screen Device And A Fabricating Method The Same”, which is hereby incorporated by reference in its entirety into this application.

### BACKGROUND OF THE INVENTION

1. Technical Field

The present invention relates to a touch screen device and a method of manufacturing the same.

2. Description of the Related Art

With the continuous development in the electronic technology and the information technology, the relative importance of electronic devices is constantly increasing in everyday life, including works. In particular, as electronic technology continuously develops, personal computers and portable transmitters etc. process texts and graphics, using a variety of input devices, such as a keyboard, a mouse, and a digitizer. These input devices, however, have been developed in consideration of the expanding usage of personal computers, such that they are difficult to be applied to portable devices that are recently reduced in size and thickness. Therefore, touch screens are on the rise as an input device appropriate for the portable devices.

Touch screens, devices installed in display devices to detect positions on the screen which a user touches and control electronic devices, using input information based on the detected contact position, in addition to controlling the picture of the display, have various advantages of being simply operated with little malfunction in a small space and very compatible with IT devices.

On the other hand, with development of mobile communication technology, it is required to implement larger-sized display picture within the restricted size of portable devices, and accordingly, the type of display using the touch screens has become the main focus. Further, the touch screens have the advantage of saving a space, as compared with the key input type, by integrating the screen with the coordinate input unit. Therefore, display devices that have been developed in recent years have been equipped with displays using the touch screens in order to more increase the screen size and convenience for users.

FIG. 1 is a cross-sectional view of a touch screen device 10 according to an example of the prior art. The touch screen device 10 according to an example of the prior art is described with reference to the figure as follows.

As shown in FIG. 1, in the touch screen device 10 of the prior art, a touch screen 11 and a display 12 are bonded by a double-sided adhesive tape 13. In this configuration, the double-sided adhesive tape 13 bonds the touch screen 11 with the display 12 at the edge portions between the touch screen 11 and the display 12.

In the touch screen device 10 according to an example of the prior art, however, since the double-sided adhesive tape 13 is disposed at the edge portions between the touch screen 11 and the display 12, an air layer 14 is formed at the inside between the touch screen 11 and the display 12, such that there was a problem that an image displayed on the display 12 under the air layer is not clearly shown to a user. That is, there was a problem that transmittance of an image is deteriorated due to the air layer 14, such that the image is distorted.

In order to solve the problem, researches for replacing the double-sided adhesive tape 13 with an optical clear adhesive (OCA) have been conducted to remove the air layer 14 between the touch screen 11 and the display 12.

FIG. 2 is a cross-sectional view of a touch screen device 20 according to another example of the prior art. The touch screen device 20 according to another example of the prior art is described with reference to the figure as follows.

As shown in FIG. 2, in the touch screen device 20 of the prior art, a touch screen 21 and a display 22 are bonded by an optical clear adhesive 23. In this configuration, the optical clear adhesive 23 is made of a transparent material and disposed over the entire surface between the touch screen 21 and the display 22. Therefore, a specific air layer is not formed between the touch screen 21 and the display 22, which improves transmittance.

However, in the touch screen device 20 according to another example of the prior art, since the optical clear adhesive 23 is provided over the entire surface between the touch screen 21 and the display 22, there was a problem that if the touch screen 21 was incorrectly bonded with the display 22, the entire optical clear adhesive 23 needed to be removed from the surfaces, when the touch screen 21 is incorrectly bonded with the display 22, and accordingly, such that it was difficult to correct.

Further, there was a problem that the relatively expensive display 22 was damaged in removing the optical clear adhesive 23, such that the time and cost for manufacturing the touch screen device 20 increases.

### SUMMARY OF THE INVENTION

The present invention has been made in effort to provide a touch screen device that has improved transmittance by removing an air layer between a touch screen and a display.

Another object of the present invention is to provide a touch screen device that reduces the manufacturing cost and the manufacturing time, because it can be easily corrected, even if a touch screen is incorrectly bonded with a display.

A touch screen device according to a preferred embodiment of the present invention includes: a touch screen; a display formed on one side of the touch screen; and an adhesive layer formed between the touch screen and the display, in which an adhesive portion is formed on the entire surface where the adhesive layer is in contact with the touch screen and on the edge portions of the surface where the adhesive layer is in contact with the display.

The adhesive portion having adhesion is formed at a portion heated in the adhesive layer.

Further, the adhesive layer is an optical clear adhesive (OCA).

Further, the adhesive layer is made of silicon, polyurethane, PVC, acryl, or a mixture thereof.

A method of manufacturing a touch screen according to a preferred embodiment of the present invention includes: (A) disposing a touch screen on one side of an adhesive layer and a display on the other side of the adhesive layer; and (B) partially bonding the touch screen with the display by heating the entire surface of the one side of the adhesive layer and the edge portions of the other side of the adhesive layer such that adhesive portions are formed over the entire surface of one side of the adhesive layer and at the edge portions of the other side of the adhesive layer, in the adhesive layer.

In step (B), the adhesive portion having adhesion is formed at a portion heated in the adhesive layer.

Further, the adhesive layer is an optical clear adhesive (OCA).

Further, the adhesive layer is made of silicon, polyurethane, PVC, acryl, or a mixture thereof.

Further, step (B) includes: (B1) bonding one side of the adhesive layer with the touch screen by heating the entire surface of the one side of the adhesive layer to form a first adhesive portion throughout the one side of the adhesive layer; and (B2) partially bonding the other side of the adhesive layer with the display by heating the edge portions of the other side of the adhesive layer to form a second adhesive portion at the edge portions of the other side of the adhesive layer.

Further, step (B2) includes: (B21) disposing a jig having an opening at the inside and a frame at the edge portions onto the touch screen or the display; and (B22) partially bonding the other side of the adhesive layer with the display by heating the frame of the jig to form a second adhesive portion at the edge portions of the other side of the adhesive layer.

### BRIEF DESCRIPTION OF THE DRAWINGS

FIG. 1 is a cross-sectional view of a touch screen device according to an example of the prior art;

FIG. 2 is a cross-sectional view of a touch screen device according to another example of the prior art;

FIG. 3 is a cross-sectional view of a touch screen device according to a preferred embodiment of the present invention;

FIGS. 4A and 4B are views illustrating an adhesive layer of the touch screen device shown in FIG. 3; and

FIGS. 5 to 9 are perspective views illustrating a method of manufacturing the touch screen device shown in FIG. 3.

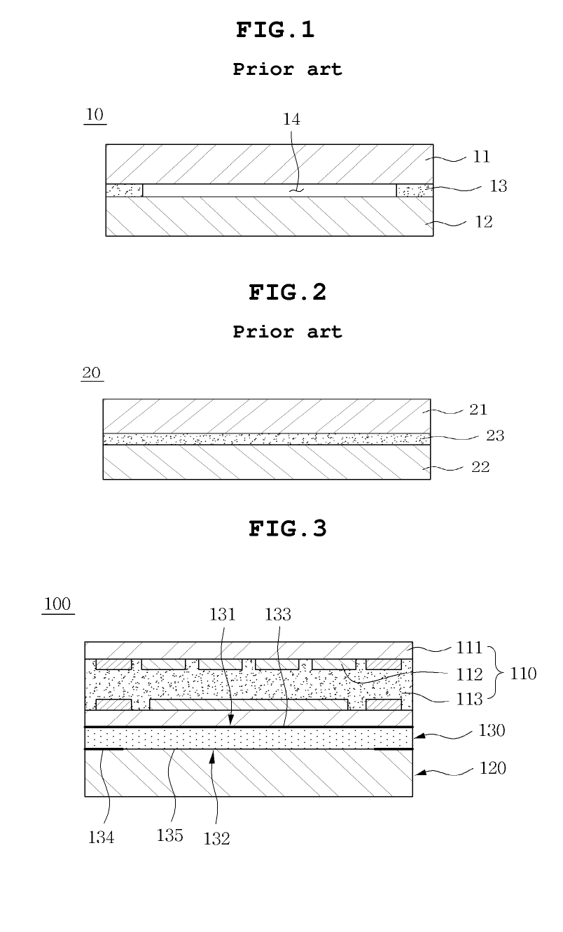

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Terms used in the specification, ‘first’, ‘second’, etc. can be used to describe various components, but the components are not to be construed as being limited to the terms. The terms are only used to differentiate one component from other components. Further, in describing the present invention, a detailed description of related known functions or configurations will be omitted so as not to obscure the subject of the present invention. Further, when it is determined that the detailed description of the known art related to the present invention may obscure the gist of the present invention, the detailed description will be omitted.

Hereinafter, preferred embodiments of the present invention will be described in detail with reference to the accompanying drawings.

Structure of Touch Screen Device

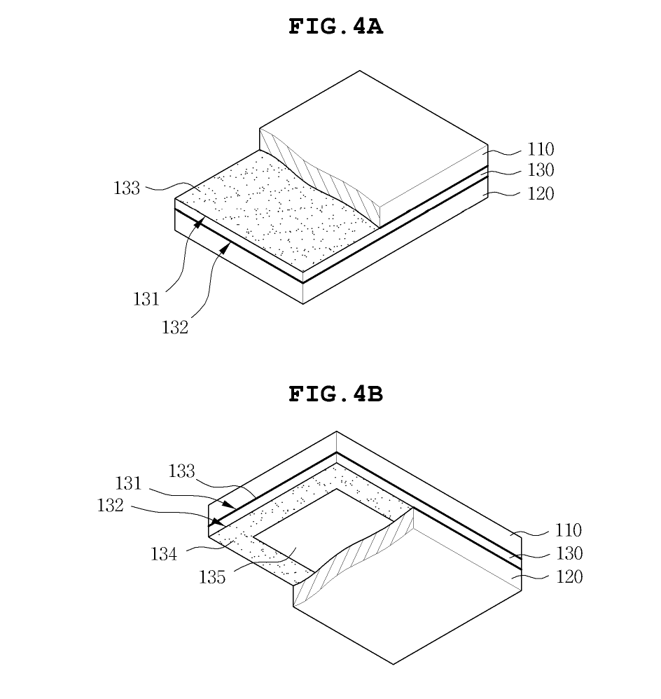

HG. 3 is a cross-sectional view of a touch screen device 100 according to a preferred embodiment of the present invention and FIGS. 4A and 4B are views illustrating an adhesive layer of the touch screen device 100 shown in FIG. 3. The touch screen device 100 according to this embodiment is described hereafter with reference to the figure.

As shown in FIG. 3, the touch screen device 100 according to this embodiment includes a touch screen 110, a display 120, and an adhesive layer 130.

The touch screen 110 is a member that receives an input from a user and transmits feedback about the input to the display 120 or a controller (not shown), and for example, resistive and capacitive touch screens can be used. Although, as an example, a capacitive touch screen 110 having two opposite transparent substrates 111 is described in this embodiment, it should be understood that the present invention is not limited thereto and includes a configuration with one transparent substrate 111 is provided, or the resistive touch screen.

In this configuration, the touch screen 110 may include two transparent substrates 111, transparent electrodes 112, and a spacer 113.

The transparent substrates 111 are a member providing a space where the transparent electrodes 112 are formed, while protecting the touch screen 110.

In this configuration, the transparent substrate 111 is a part receiving an input from a specific object, such as the user's body or the stylus pen and preferably made of a material having large durability. Further, the window plate 120 is made of a transparent material for a user to be able to see the display well, and for example, may be made of polyethylene terephthalate or glass.

Meanwhile, it is preferable to apply high-frequency treatment or primer treatment to one side of the transparent substrates 111 to improve the attachment with the transparent electrodes 112.

The transparent electrodes 112 are elements formed on one side of the transparent substrates 111 and senses signals from contact or access of specific objects.

In this configuration, the transparent electrodes 112 senses change in capacitance from contact or access of a specific object, such as the user's body or a stylus pen, and transmit the changes to the controller (not shown), and then the controller (not shown) converts the analog signals into digital signals and simultaneously recognizes the coordinates of the pushed position, thereby implementing desired operations. In detail, when high frequency is dispersed throughout the transparent electrodes 112 by an applied voltage and then there is contact or access by a human body etc., a predetermined change occurs in capacitance while the transparent electrodes 112 function as electrodes and the transparent substrates 111 function as dielectrics, and the controller (not shown) can recognize the contact position or whether there is an access, by detecting the changed waveform.

Meanwhile, the transparent electrodes 112 are made of a transparent material for a user to be able to see the display 120 under them, and preferably have conductivity. For example, the transparent electrodes 112 may be made of conductive polymer containing poly-3,4-ethylenedioxythiophene/polystyrenesulfonate (PEDOT/PSS), polyaniline alone or a mixture thereof, or metal oxides, such as indium tin oxide (ITO). Further, the transparent electrodes 112 may have various shapes, such as a rod shape, a diamond shape, a hexagonal shape, an octagonal shape, and a triangular shape.

The spacer 113 insulates transparent electrodes 112 on the transparent substrates 111, bonding the two transparent substrates 111. In this configuration, although the material of the spacer 113 is not specifically limited, it is preferable to use an optical clear adhesive having both insulation and adhesiveness.

The display 120, a member displaying an image to a user, is bonded to one side of the touch screen 110 by the adhesive layer 130.

In this configuration, the display 120 is a member for displaying images for information transmission to the user and showing reaction when the user touches the touch screen 110, to the user. The display 120 may be, for example, a liquid crystal display (LCD), a plasma display panel (PDP), an electroluminescence (EL), or a cathode ray tube (CRT).

As an example, when the display 120 is a thin film transistor (TFT) liquid crystal display, the display 120 may include a lower plate where thin film transistors and pixel electrodes are arranged, an upper plate having color filter for displaying colors and common electrodes, and a liquid crystal filled between the upper plate and the lower plate. Further, a polarizer may be attached to the upper plate and the lower plate, respectively, to linearly polarize visible light (natural light).

The adhesive layer 130 is a member partially bonding the touch screen 110 with the display 120 and both sides of the adhesive layer 130 is divided into adhesive portions 133 and 134 and a non-adhesive portion 135.

In this configuration, as shown in FIG. 4A, one side 131 of the adhesive layer 130 is a surface contacting with the touch screen 110 and provided over the entire surface with the first adhesive portion 133 having adhesion. Therefore, the adhesive layer 130 and the touch screen 110 can be bonded over the entire contact surfaces.

Further, as shown in FIG. 4B, the other side 132 of the adhesive layer 130 is a surface contacting with the display 120 and provided with the second adhesive portion 134 at the edge portions and the non-adhesive layer 135 at the inside. Therefore, since the other side 132 of the adhesive layer 130 and the display 120 are bonded only at the edge portions and the insides are just in contact, such that the other side 132 of the adhesive layer 130 and the display 120 can be partially bonded.

Meanwhile, it is preferable that the adhesive layer 130 is one specific material such that the adhesive portions 133 and 134 and the non-adhesive portion 135 can be divided from one material. For example, a material that has adhesion only where heat is applied may be used for the adhesive layer 130. As the material, the adhesive layer 130, for example, may be made of silicon, polyurethane, PVC, acryl, or a mixture thereof.

Further, it is preferable that the adhesive layer 130 is made of a transparent material for the user to be able to easily see the display 120 under it, and for example, it may be made of an optical clear adhesive (OCA).

On the other hand, since the other side 132 of the adhesive layer 130 has the second adhesive portion 134 only at the edge portions, it is easy to separate the touch screen 110 from the display 120. The inside of the display 120 is just in contact with the adhesive layer 130, it is required to take off only the second adhesive portion 134 at the edge portions of the display 120 in order to separate the touch screen 110 from the display 120. Therefore, when the touch screen 110 is incorrectly bonded with the display 120, correction is easy and it is possible to prevent damage to the relatively expensive display 120. Further, since the non-adhesive portion 135 exists at the inside of the adhesive layer 130, it is possible to reduce distortion of refractive index and transmittance, as compared with when an air gap is formed by using a double-sided adhesive tape.

Method of Manufacturing Touch Screen

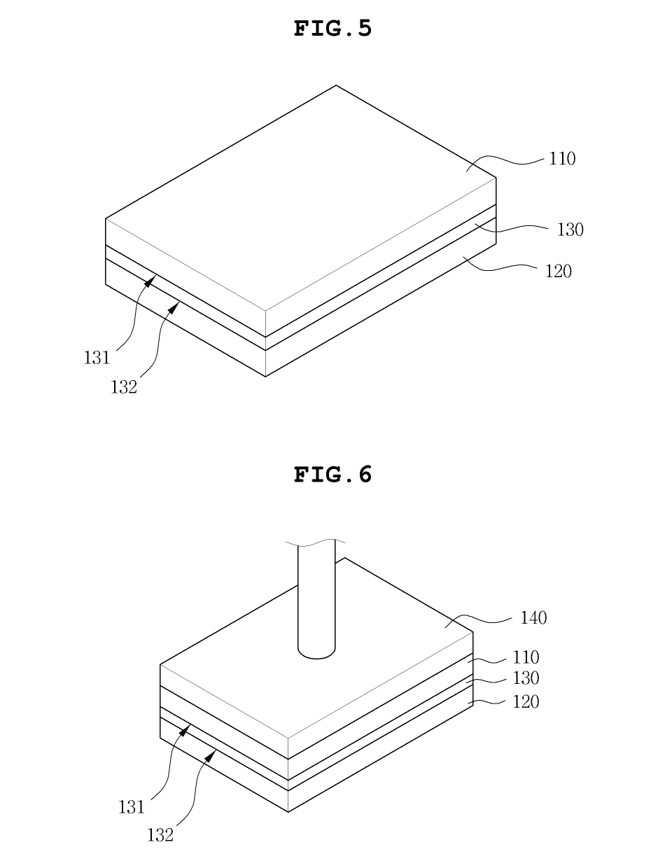

FIGS. 5 to 9 are perspective view illustrating a method of manufacturing the touch screen device 100 shown in FIG. 3. A method of manufacturing the touch screen device 100 according to a preferred embodiment of the present invention is described with reference to the figure as follows.

First, as shown in FIG. 5, the touch screen 110, the adhesive layer 130, and the display 120 are sequentially disposed.

The touch screen 110 is disposed on the side 131 of the adhesive layer 130 and the display 120 is disposed on the other side 132. In this configuration, the side 131 of the adhesive layer 130 and the touch screen 110, and the other side 132 of the adhesive layer 130 and the display 120, may be respectively just in contact and not bonded. Meanwhile, it is preferable that the adhesive layer 130 is made of an optical clear adhesive (OCA) having transparence such that an image on the display 120 can be shown to the user through the adhesive layer 130.

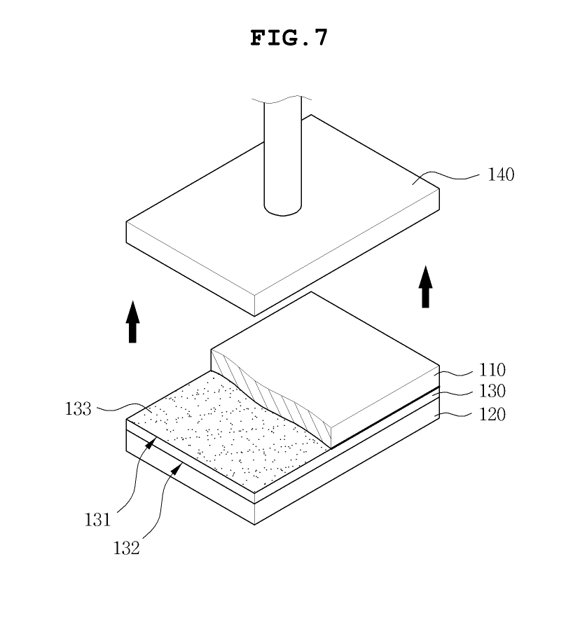

Next, as shown in FIGS. 6 and 7, a heating unit 140 is disposed on the touch screen 110 and transfers heat throughout the side 131 of the adhesive layer 130.

In this configuration, the heating unit 140, for example, may be a flat plate covering the entire surface of the touch screen 110. When the heating unit 140 is a flat plate, the heat generated from the heating unit 140 can be uniformly transferred to the side 131 of the adhesive layer 130 through the touch screen 110.

Meanwhile, the heat generated from the heating unit 140 is transferred to the entire surface of the side 131 of the adhesive layer 130 and the first adhesive portion 133 is formed over the entire side 131 of the adhesive layer 130, thereby generating adhesion. Therefore, the touch screen 110 and the side 131 of the adhesive layer 130 can be bonded over the entire surface.

Meanwhile, although it was described in this embodiment that heat is transferred from the upper surface of the touch screen 110 to the side 131 of the adhesive layer 130, it may be possible to transfer heat from the upper surface of the display 120.

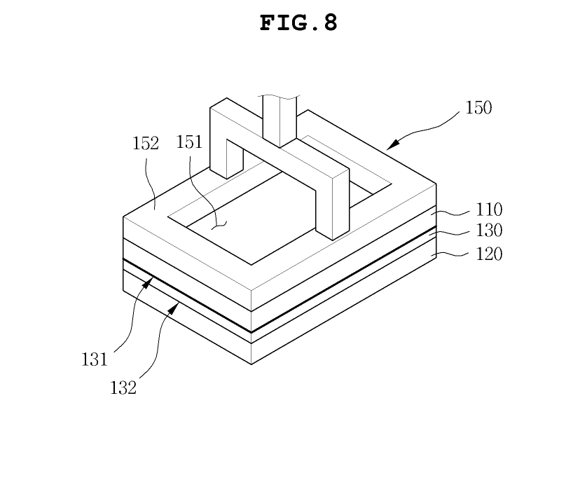

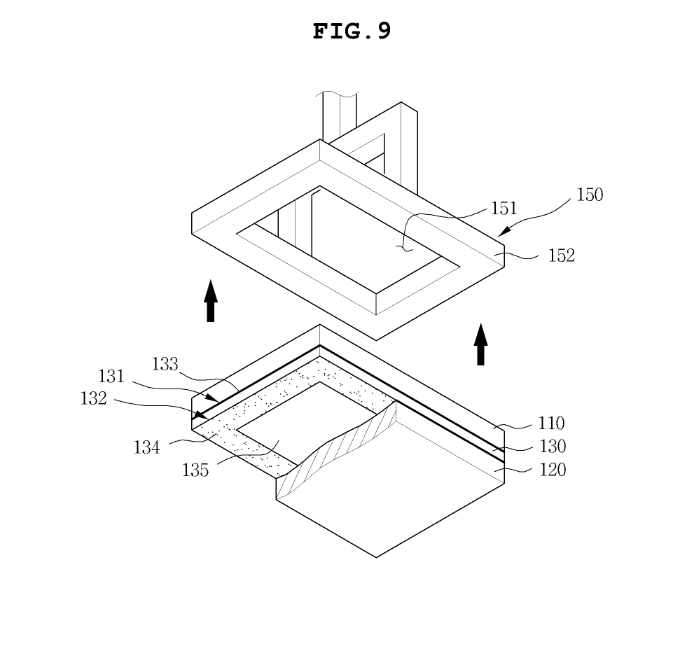

Next, as shown in FIGS. 8 and 9, a jig 150 is disposed on the touch screen 110 and transfers heat to the edge portions of the other side 132 of the adhesive layer 130.

In this configuration, the jig 150 is a part for transferring heat only to the edge portions of the other side 132 of the adhesive layer 130 and shaped in a frame 152 having an opening 151 therein. In detail, the frame 152 is formed at the portions corresponding to the edge portions of the other side 132 of the adhesive layer and the opening 151 is formed at the portion corresponding to the inside.

As the jig 150 is disposed on the touch screen 110 and heat is applied to the frame 152 of the jig 150, the heat can be transferred to the edge portions of the other side 132 of the adhesive layer 130 through the touch screen 110 and the adhesive layer 130. Therefore, the second adhesive portion 134 having adhesion can be formed at the edge portions of the other side 132 of the adhesive layer 130 and the non-adhesive portion 135 not having adhesion can be formed at the inside of the other side 132 of the adhesive layer 130. Since the other side 132 of the adhesive layer 130 is divided into the second adhesive portion 134 and the non-adhesive portion 135, the other side 132 of the adhesive layer 130 and the display 120 can be partially bonded.

On the other hand, although it was described in this embodiment that the jig 150 is disposed on the touch screen 110, it is possible to dispose the jig on the display 120 to transfer heat to the edge portions of the other side 132 of the adhesive layer 130.

The touch screen device 100 according to a preferred embodiment shown in FIG. 3 can be achieved by the manufacturing process.

According to the present invention, the touch screen device has the advantage of improving transmittance and reducing distortion of an image, because the specific air layer is not formed due to the adhesive layer formed over the entire surface between the touch screen and the display.

Further, according to the present invention, since the second adhesive portion is formed at the edge portions on the surface where the adhesive layer is in contact with the display, correction is easy, even if the display is incorrectly bonded with the touch screen, and accordingly, it is possible to reduce the manufacturing cost and the manufacturing time of the touch screen device.

Further, according to the present invention, heat is transferred only to the edge portions of the surface where the adhesive layer is in contact with the display, by using the jig having the opening at the inside and the frame at the outside, such that the second adhesive portion can be easily formed.

Although the embodiment of the present invention has been disclosed for illustrative purposes, it will be appreciated that a touch screen device and a method of manufacturing the same according to the present invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch screen device comprising:
a touch screen;
a display formed on one side of the touch screen; and
an adhesive layer formed between the touch screen and the display,
wherein, an adhesive portion is formed on the entire surface where the adhesive layer is in contact with the touch screen and on the edge portions of the surface where the adhesive layer is in contact with the display.

2. The touch screen device as set forth in claim 1, wherein the adhesive portion having adhesion is formed at a portion heated in the adhesive layer.

3. The touch screen device as set forth in claim 1, wherein the adhesive layer is an optical clear adhesive (OCA).

4. The touch screen device as set forth in claim 1, wherein the adhesive layer is made of silicon, polyurethane, PVC, acryl, or a mixture thereof.

5. A method of manufacturing a touch screen, comprising:
(A) disposing a touch screen on one side of an adhesive layer and a display on the other side of the adhesive layer; and
(B) partially bonding the touch screen with the display by heating the entire surface of the one side of the adhesive layer and the edge portions of the other side of the adhesive layer such that adhesive portions are formed over the entire surface of one side of the adhesive layer and at the edge portions of the other side of the adhesive layer.

6. The method of manufacturing a touch screen device as set forth in claim 5, wherein in the step (B), the adhesive portion having adhesion is formed at a portion heated in the adhesive layer.

7. The method of manufacturing a touch screen device as set forth in claim 5, wherein the adhesive layer is an optical clear adhesive (OCA).

8. The method of manufacturing a touch screen device as set forth in claim 5, wherein the adhesive layer is made of silicon, polyurethane, PVC, acryl, or a mixture thereof.

9. The method of manufacturing a touch screen device as set forth in claim 5, wherein the step (B) includes:
(B1) bonding one side of the adhesive layer with the touch screen by heating the entire surface of the one side of the adhesive layer to form a first adhesive portion throughout the one side of the adhesive layer; and
(B2) partially bonding the other side of the adhesive layer with the display by heating the edge portions of the other side of the adhesive layer to form a second adhesive portion at the edge portions of the other side of the adhesive layer.

10. The method of manufacturing a touch screen device as set forth in claim 9, wherein the step (B2) includes:
(B21) disposing a jig having an opening at the inside and a frame at the edge portions onto the touch screen or the display; and
(B22) partially bonding the other side of the adhesive layer with the display by heating the frame of the jig to form a second adhesive portion at the edge portions of the other side of the adhesive layer.
